(19) United States
(12) Patent Application Publication
(10) Pub. No.: US 2008/0107124 A1
(43) Pub. Date: May 8, 2008

(54) SYSTEM AND METHOD FOR SUPPORTING MOBILITY AND MULTIPATH PACKET DELIVERY IN IP COMMUNICATIONS AND COMPUTER NETWORKS ACROSS NAT AND FIREWALL BOXES

(76) Inventor: JORDI ROS-GIRALT, Aliso Viejo, CA (US)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/934,858

(22) Filed: Nov. 5, 2007

Related U.S. Application Data
(60) Provisional application No. 60/864,517, filed on Nov. 6, 2006.

(51) Int. Cl. H04L 12/56

(52) U.S. Cl. 370/401

(57) ABSTRACT

The present invention generally relates to a system and method for supporting (1) mobility in IP (Internet Protocol) networks and (2) multipath packet delivery when the communication paths between a group of senders and a group of receivers traverse one or more NAT and Firewall IP boxes. While at first sight mobility and multipath packet delivery may appear to be two orthogonal or somewhat independent problems, the present invention shows not only that they are intimately related but also that with the correct framework in hand, both problems can be naturally solved.

### REFERENCE TO RELATED APPLICATIONS

This application claims an invention which was disclosed in Provisional Application No. 60/864,517, filed Nov. 6, 2006 entitled “SYSTEM AND METHOD FOR SUPPORTING MOBILITY AND MULTIPATH PACKET DELIVERY IN IP COMMUNICATIONS AND COMPUTER NETWORKS ACROSS NAT AND FIREWALL BOXES”. The benefit under 35 USC § 119(e) of the United States provisional application is hereby claimed, and the aforementioned application is hereby incorporated herein by reference.

### FIELD OF THE INVENTION

The present invention has two related fields of invention: mobility management and network convergence. More specifically, the present invention relates to system and method for supporting mobility and multipath packet delivery in IP communications and computer networks across NAT and firewall boxes.

### BACKGROUND OF THE INVENTION

The original Internet Protocol was not designed for mobility. The fundamental problem is that Internet packets use IP addresses as globally unique identifiers to reach a set of certain terminals in the network. If a terminal moves from a network A to a new network B, it must acquire a new IP address so that packets can be routed to it through the new network. In doing so, without an IP mobility technology all the connections that were active when the terminal was in network A will break when the terminal enters network B and acquires a new IP address. This occurs because the upper transport layer protocols, on top of IP (including TCP and UDP), bind IP connections between two terminals to the IP addresses of the terminals. If a terminal acquires a new IP address, such binding breaks and the connection must be dropped.

With the arrival of high speed wireless technologies, users are now demanding seamless uninterrupted connectivity as they move across networks. In brief, the mobile IP problem defined above must be resolved. Therefore, it is desirable to provide an improved method or system for IP mobility.

### SUMMARY OF THE INVENTION

The present invention provides a generic framework and a set of techniques to solve the problems of IP mobility and multipath packet delivery (or network convergence) when the communication paths between a group of senders and a group of receivers traverse one or more NAT and Firewall IP boxes.

It is an object of the present invention to provide a set of techniques to resolve the DNF mobility problem with the following two improvements:
that the scheme or method must be plug-and-play, that is to say, that NAT and firewall boxes need not be re-configured in order to enable the mobility and MPD protocol.
that the overall communication system must be no less secure with enabled mobility and/or MPD than it was without the enabling mobility and/or MPD.

Notice that Mobile IP RFC 3519, while solving the DNF mobility problem, it does not satisfy neither of the two conditions above. Because (1) it requires IT and network managers to reconfigure their firewall boxes to open port 434 imposing additional burdens on their management work, and (2) it induces a new security glitch in their IP system.

In particular, RFC 3519 states: “The primary assumption in this document is that the network allows communication between an UDP port chosen by the mobile node and the home agent UDP port 434. If this assumption does not hold, neither Mobile IP registration nor data tunneling will work” It is an object of the present invention to provide a system and method for solving the DNF mobility problem while not constrained by this assumption.

The present invention differs fundamentally from MIP RFC 3519 in that it will not require the establishment of a UDP tunnel and hence it will avoid the configuration of NAT and firewall boxes.

It is another object of the present invention to provide a generic framework that can not only solve the IP mobility problem, but also the network convergence problem, which is also referred to as the multipath packet delivery problem.

It is yet another object of the present invention to provide a mechanism to allow mobility and network convergence without breaking connections at the socket layer.

It is still yet another object of the present invention to provide an embodiment by which the previous framework of IP mobility and network convergence with support for NAT and firewall traversal can be easily implemented in current legacy devices.

### BRIEF DESCRIPTION OF THE DRAWINGS

The above and other objects and features in accordance with the present invention will become apparent from the following descriptions of preferred embodiments in conjunction with the accompanying drawings, and in which:

FIG. 1 shows a possible embodiment of a mobility communication system having a cooperative stack (costack) is inserted next to the IP layer to enable the operations presented in this invention; in which the costack performs two main operations: (1) generation of new control plane packets and (2) manipulation of existing data plane packets.

FIG. 2 shows a possible embodiment of method [T.1.1], in which a control packet is embodied into a SYN packet.

FIG. 3 illustrates a situation in which the method in FIG. 2 fails to traverse the NAT+firewall boxes and a more complete emulation of connection request is implemented, wherein the SYN packet carries no control information, which instead is piggybacked on a succeeding ACK packet.

FIG. 4 shows a complete emulation of connection setup to convey control information to CT, in case the method in FIG. 3 fails to traverse the NAT+firewall boxes.

FIG. 5 illustrates another embodiment of the costack module for the case of middle boxes.

FIG. 6 illustrates the c-forwarding operation implemented in an IP node in that upon receiving an IP packet labeled with a connection ID (CID), the node looks up its corresponding status table entry and swaps its original tetrad T with T′.

FIG. 7 illustrates the c-forwarding operation in splitting mode in that upon receiving an IP packet labeled with a connection ID (CID), the node looks up its corresponding status table entry and swaps its original tetrad T with one of the tetras indicated in this status table entry.

FIG. 8 illustrates how c-forwarding operations can be used to solve the mobility problem without breaking transport and socket layers.

FIG. 9 illustrates that by applying a simple modification to FIG. 8 (mainly changing one forwarding node for one splitting node), the same configuration can be used to provide multipath packet delivery without breaking transport and socket layers.

### DETAILED DESCRIPTION OF THE PRESENT INVENTION

Certain embodiments as disclosed herein provide for a MAC module that is configured to be deployed in a wireless communication device to facilitate multi-hop wireless network communications over high bandwidth wireless communication channels based on UWB, OFDM, 802.11/a/b/g, among others. In one embodiment, the nodes involved in the multi-hop wireless communications are arranged in a mesh network topology. For example, one method as disclosed herein allows for the MAC module to determine the network topology by parsing beacon signals received from neighbor nodes within communication range and establish high bandwidth communication links with those nodes that are within range to provide a signal quality that supports high bandwidth communication. For applications that require a certain level of quality of service, the methods herein provide for establishing a multi-hop end-to-end route over the mesh network where each link in the route provides the necessary level of signal quality.

After reading this description it will become apparent to one skilled in the art how to implement the invention in various alternative embodiments and alternative applications. To facilitate a direct explanation of the invention, the present description will focus on an embodiment where communication is carried out over a UWB network, although the invention may be applied in alternative networks including 802.11, 802.15, 802.16, worldwide interoperability for microwave access (“WiMAX”) network, wireless fidelity (“WiFi”) network, wireless cellular network (e.g., wireless wide area network (“WAN”), Piconet, ZigBee, IUP multimedia subsystem (“IMS”), unlicensed module access (“UMA”), generic access network (“GAN”), and/or any other wireless communication network topology or protocol. Additionally, the described embodiment will also focus on a single radio embodiment although multi-radio embodiments and other multiple input multiple output (“MIMO”) embodiments are certainly contemplated by the broad scope of the present invention. Therefore, it should be understood that the embodiment described herein is presented by way of example only, and not limitation. As such, this detailed description should not be construed to limit the scope or breadth of the present invention as set forth in the appended claims.

Before addressing details of embodiments described below, some terms are defined or clarified. As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

In the following description of the invention, single-medium multiple-access communication systems are assumed to be the intended applicable systems. This assumption is in no way a restriction of the general applicability of the present invention.

It is further noted that the problem of IP mobility becomes even more challenging when the communication data path after movement traverses one or more NAT and firewall boxes. NAT boxes separate private domains from public domains. Hosts attached to the public Internet via a NAT box are given private IP addresses which are only routable in the local domain in which they reside. This adds complexity to the problem of IP mobility in that upon moving from one network to another which sits behind a NAT, the host will acquire a private IP address which has no meaning outside its local area network. In this setup, how can a sender sitting at the other end of the communication path know where to send the new packets is the question or problem. To resolve this problem, some sort of control information must be conveyed from the mobile terminal to the sender (or some middle point in between) regarding its new location. If, in addition, a firewall box sits in the data path, the sending of this control information must be performed in a way that the same can survive the deep packet inspection and filtering algorithms executed by the firewall.

In the scope of the present invention, we will henceforth refer to the above problem of IP mobility when the communication path after movement traverses at least one or more NAT and/or firewall boxes as the Dynamic NAT and Firewall (DNF) mobility problem. IP mobility has been studied by both the scientific and the telecom industry communities, usually in cooperation. The main result of these efforts has been a suite of IETF standards that aim at solving the mobility problem in IP-based networks. The following is a brief summary of some important events related to the present invention:

In 1996, RFC 2002 introduced the Mobile IP (MIP) as the global standard for IP mobility. As IETF was vigorously opposed to NAT boxes (since they break the treasured rule of each “IP node with one globally unique IP address”), MIP as defined in RFC 2002 was not designed to support NAT traversal. By the late 1990s and beginning of new millennium, it was clear that market forces lead to an implosion of NAT boxes at the edge of the Internet, as more and more enterprises and end-users chose NATs as their preferred way to attach to the Internet and manage their local networks. In consequence, In 2003, RFC 3519 [3] introduced a mechanism to solve the NAT traversal problem for the Mobile IP protocol introduced in RFC 2002. The solution is based on UDP tunneling and requires the opening of UDP port 434 in all firewall boxes across the communication path, imposing additional burden to the IT managers of corporations as well as a new potential security glitch.

While Mobile IP suffers from some other limitations (e.g. triangular routing, lack of end-to-end architecture, simultaneous mobility, . . . ), the present invention focuses on the specific issue of IP mobility in the context of NAT and firewall boxes. It is noted that some forms of mobile IP (MIP) can solve some of these problems, but there is no generic form or scheme that can solve all of the problems at the same time. For instance, triangular routing can be solved via MIP-RO (MIP with Route Optimization), but MIP-RO introduces the problem of simultaneous movement.

The present invention also considers a second application, that of network convergence. By deriving a framework for solving the IP mobility problem, the present invention will show that the mobility problem is intimately related to a more generic family of protocols, mainly those related to multipath packet delivery (MPD), which in turn are key protocols to provide network convergence. Therefore, with minimum additional cost, if the correct framework is derived, two problems that are apparently different in terms of their practical applications can be solved with the same technology.

The notion of multipath packet delivery is intimately related to the problem of IP mobility. As an example, consider the case of a soft handoff situation. In this case, a device moving from one network Na to another Nb, will first make a new connection to Nb before breaking the connection from Na. Once the connection to Nb has been established, the device can drop the connection to Na. But between the time the device finishes establishing a connection to Nb and the time it breaks the connection to Na, the device is using both networks at the same time. Hence, the soft handoff case can be considered as a simple short-lived form of multipath packet delivery.

Generally, MPD can be seen as a generalization of IP mobility if defined as follows: that a terminal is capable of performing multipath packet delivery if within a single IP connection (for instance UDP or TCP connections, although not limited to these 2 cases) being capable of sending packets to the receiving node (or nodes) over an arbitrary number N (N being a positive integer) of available networks, while these networks can be different at different moments during the lifetime of the connection.

We observe that MPD becomes a solution to IP mobility when N is equal to 1 (to be more precise, in IP mobility N is only different than 1 for a short period of time while performing the handoff operation; in particular, during the handoff operation N becomes 2 or 0 in the cases of soft or hard handoff, respectively).

For instance, suppose that a user is moving and traversing multiple networks that may or may not overlap. If the user has a device that is MPD capable, then such device will be able to add and remove new networks and send packets over each of them on a per packet basis without breaking the connectivity of any active IP connection. If the device can only use 1 network at a time (and only 2 for the short-lived situation of soft handoff or 0 for the short-lived situation of a hard handoff), then we can say that the device is performing IP mobility. If the device can use 2 or more networks at the same time (other than for the case of soft handoff), then we can say that the device is performing MPD.

As mentioned, the present invention pays special attention to the problem of NAT and firewall traversal. The set of techniques presented in this invention to solve the NAT and firewall traversal problems is not only applicable to IP mobility but is also applicable to the more generic problem of multipath packet delivery.

Despite being a tremendous success, increasingly, the IP protocol suite has been criticized as being too inflexible for the wide-ranging and rapidly evolving application requirements. Two examples of “Internet rigidity” are (1) host mobility and (2) single path packet delivery. Some legacy constraints make the problem of IP mobility a cumbersome one. For instance, in a typical socket architecture (sockets is an API layer that allows applications to create transport layer connections), connections are by definition bound to a tetrad of source and destination IP addresses and port numbers. Hence if the IP address of a network port is changed while a socket is alive, by definition the connection associated with this socket will break.

The problem of network convergence can be seen as another instance of Internet rigidity. For instance, while in typical computer networks the number of possible paths between a source and a destination is very large, most IP protocols today are defined to use single path connectivity (the two best examples are TCP and UDP protocols). A well-known problem with this legacy design is the so-called fish problem. Routing protocols typically force packets to use the fastest path between sources and destinations; as a consequence, connections tend to be synchronized by the following process: at time T1 all connections find a certain common path P1 to be optimal, while all other possible paths become idle; this induces large congestions on P1 making it a suboptimal path, which in turn triggers all connections to react by using a new best path P2 at time T2 while all other possible paths become idle; but again the new path P2 becomes immediately congested; the process is repeated indefinitely, inducing large network instabilities and inefficient utilization of network resources.

Multipath protocols are a solution to the fish problem in the sense that path diversification leads to a more balanced load of network traffic. But the problem of multipath communication has probably a more important implication in today's networks: that of network convergence. This concept refers to the capability of a networking system to flexibly, dynamically and transparently integrate networks of different kinds into a single logical pipe with resources equal to the sum of all resources of each of the networks. An example of network convergence could work as follows: a user is in the park and decides to watch the news by using IPTV on her Internet tablet. A single UDP connection is established that starts streaming the news over a certain network, for instance a Wireless Broadband (WIBRO) network. But the device detects the existence of a second network, let's say an High-Speed Downlink Packet Access (HSDPA) network, and decides to pull resources from both WIBRO and HSDPA networks at the same time to achieve a higher quality stream. The user then decides to go for a cup of coffee. As she enters a coffee shop, her Internet tablet detects a third network, for instance a small WIFI network in the shop. So the device pulls this third resource to achieve an even higher quality of the stream.

Based on this example, an immediate implication of network convergence is that a technology is needed to deliver packets using multiple paths even if the connection between the user and the source of the content is single path in nature (e.g. in the previous example, a single path UDP connection).

Both mobility and network convergence are complex problems, since the Internet was not originally designed for them. Moreover, their complexity also increases if communication paths between sources and destinations traverse NAT and firewall boxes. A good example illustrating the problem of NAT traversal can be found in the field of VoIP communications. The most famous communication standard for VoIP uses a protocol named SIP (Session Initiation Protocol), but SIP was not designed to support NAT and firewall boxes across the communication path. In a market driven economy, mechanism are provided for technology to evolve even if a standard lacks the right functionality. In 2003 a private company with the name Skype provided a new VoIP solution capable of solving the NAT and firewall traversal problems. Skype solved the NAT traversal problem when terminals are static, i.e. without mobility. The present invention focuses on the dynamic problem of NAT and firewall traversal, i.e. the problem of maintaining connectivity when users move across different networks and when communication paths are set across NAT and firewall boxes.

The present invention provides a generic framework and a set of techniques to solve the problems of IP mobility and multipath packet delivery (or network convergence) when the communication paths between a group of senders and a group of receivers traverse one or more NAT and Firewall IP boxes.

The following definitions will be used in the description of the present invention:

| | |
|---|---|
| IP node: | a logical device with an IP address and capability to process IP packets. |
| Terminal: | an IP node that can be used by a human to interface with an IP |
| | network (e.g. a host computer, a mobile phone with GPRS |
| | connectivity, etc.). |
| MT (Mobile | a terminal that can move from one network location to another |
| Terminal): | while one or more of its connections (e.g. TCP or UDP |
| | connections) are active. |
| CT | a terminal that is communicating with an MT at the other end-point |
| (Corresponding | of the connection. |
| Terminal): | |
| IP connection | a set of packets traveling between from one terminal (TR1) to the |
| (or simply a | second terminal (TR2), carrying the same IP tetrad. An IP tetrad (or |
| connection): | simply a tetrad) consists of: (1) TR1's IP address (ipa_tr1), (2) |
| | TR1's TCP or UDP port number (prt_tr1), (3) TR2's IP address |
| | (ipa_tr2) and (4) TR2's TCP or UDP port number (prt_tr2). The |
| | tetrad is organized into an ordered structure as in [ipa_tr1, prt_tr1, |
| | ipa_tr2, prt_tr2] and the symbols such as T, T′, T″, or Tⁿ, are used |
| | as particular instances of tetrads; for example, T = [ipa_tr1, prt_tr1, |
| | ipa_tr2, prt_tr2]. |

The first key step in the design of the present invention is to reduce the DNF mobility problem into a subset of indivisible and fundamental problems. Assume that MT moves from network NA to network NB. We separate the mobility problem into two main sub-problems: the downstream problem, that which involves data packets traveling from CT to MT, and the upstream problem, that which involves data packets traveling from MT to CT.

Consider the downstream problem. It is argued that: in order to resolve the IP mobility problem, upon moving from network NA to network NB, MT must somehow communicate some control information to CT which should allow CT to find the means to continue to send packets to MT at its new location. If MT and CT are separated by NAT and firewall boxes, how can we guarantee that such control packets will be able to cross these boxes (surviving operations as diverse as deep packet inspections, packet filtering, NAT port mapping and NAT hole-punching) and arrive correctly at CT is the question or the problem to be solved by the present invention. We will refer to this sub-problem as the downstream control plane (DCP) mobility problem.

Assuming that CT can correctly receive the control packets, if MT and CT are separated by NAT and firewall boxes, how can we guarantee that the new data packets originated from CT will be able to make their way to MT across these boxes (surviving operations as diverse as deep packet inspections, packet filtering, NAT port mapping and NAT hole-punching) and arrive correctly at MT? We refer to this sub-problem as the downstream data plane (DDP) mobility problem.

Consider the upstream problem. If is argued that: in order to resolve the IP mobility problem, upon moving from network NA to network NB, if MT and CT are separated by NAT and firewall boxes, MT needs to generate packets that must be able to make their way to CT across these boxes (surviving operations as diverse as deep packet inspections, packet filtering, NAT port mapping and NAT hole-punching). We will refer to this sub-problem as the upstream data plane (UDP) mobility problem.

In summary, any mobility protocol must resolve three basic problems: 2 relating to the downstream communication path (for control and data planes) and 1 relating to the upstream communication path (for data plane). Notice that there is no upstream control plane problem, since MT is fully aware of its recent movement and new location and its own (control plane) communication of the new location is a redundant operation.

Next, we will present a set of new techniques to resolve each of the three basic mobility problems.

Methods for Solving the DCP Mobility Problem

We further decompose the DCP problem by observing that there are two cases: the communication between MT and CT follows a client/server model and CT performs the role of a server (hence MT is the client), or the negate of (1) is true.

Let us start with case (1). A method for solving the DCP mobility problem works as follows: [T.1.1] MT piggybacks control information conveying its new location onto a packet that imitates the initiation of a new connection with the server CT. Notice that this packet will survive both the NAT and firewall mapping and filtering functions since by definition the generated packet triggers the initiation of a new connection. That is, if client MT was able to establish a connection to server CT in the original network NA, then it should also be able to establish a new connection to server CT at a new network NB, and hence the control information embedded in this special form of connection initiation packet should survive NATs and firewalls.

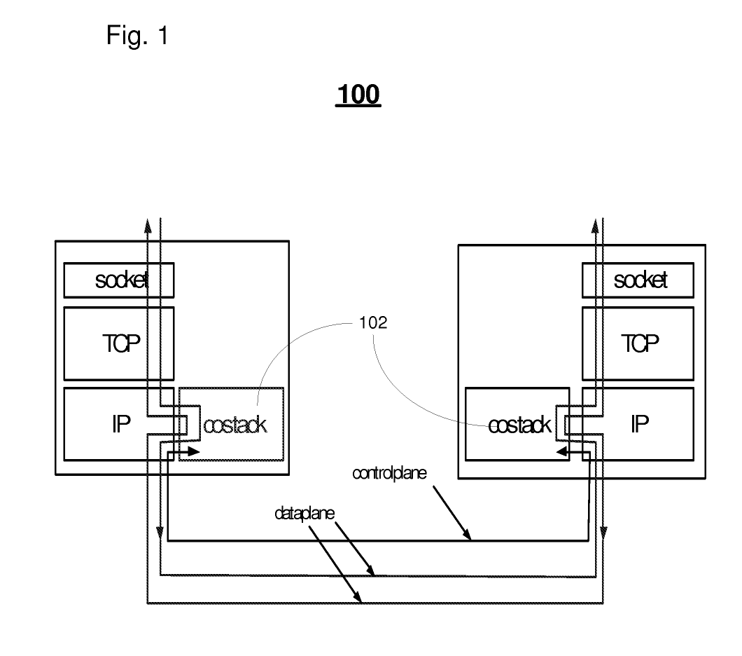

Notice that the generation of this control packet is only intended for the purpose of solving the mobility problem. An interception technique must be deployed at the IP nodes participating in the mobility protocol to intercept this especial packets, process them and drop them so that no actual connection is initiated by the upper layer protocols (e.g. TCP, UDP, etc . . . ). A possible embodiment (while not the only one) of this interception technique can be implemented at the IP layer, since this is the highest layer unaware of connections. As shown in FIG. 1, a possible embodiment 100 of a mobility communication system. A cooperative stack 102 (costack) is inserted next to the IP layer to enable the operations presented in this invention. Costack 102 performs two main operations: (1) generation of new control plane packets and (2) manipulation of existing data plane packets.

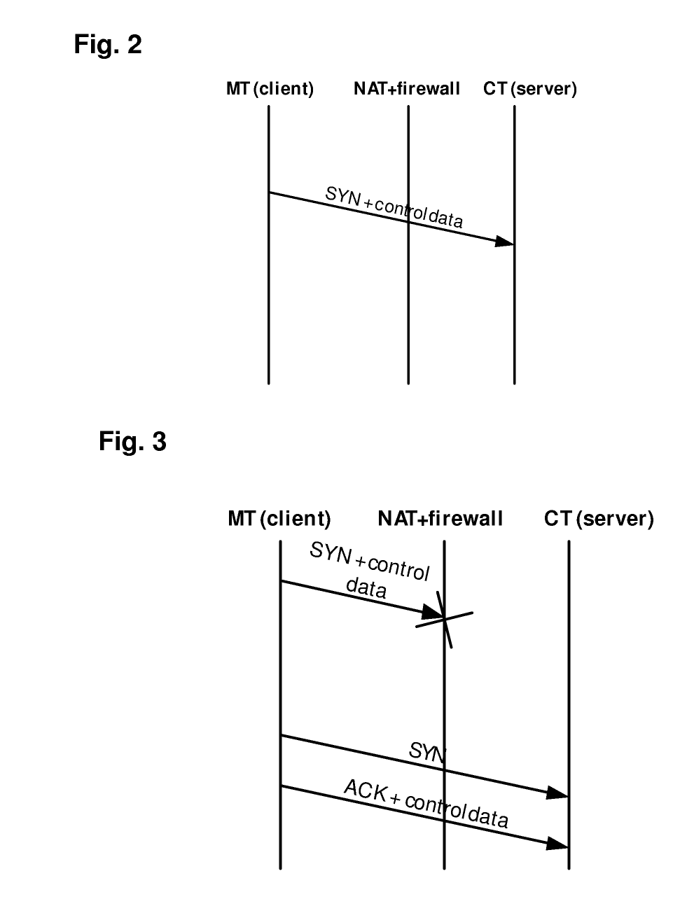

While the above method is generic in its form, next we present several practical examples. In the case of TCP, the control information can be piggybacked on a SYN packet with the same destination port number as the destination port number of the connection that is being mobilized. Notice that NAT and firewalls boxes may not drop this SYN packet since by definition, in the first instance, client MT used this same SYN packet when in network NA to establish a connection with server CT. Referring to FIG. 2, a method [T.1.1], in which a control packet is embodied into a SYN packet in that control data is included or associated with the SYN packet.

In some cases, high-end firewalls performing deep packet inspection may decide to drop the SYN packet when noticing that it carries a payload with more than zero bytes (while the TCP standard does not prohibit SYN packets to carry a payload, most application layer protocols don't exercise this option and hence a firewall may consider it a ‘suspicious’ packet and decide to drop it). In this case, a more elaborated technique to convey the control information can be used: the MT generates first a TCP SYN packet with zero payload and then it generates a second TCP ACK packet with non-zero payload carrying the control information as shown in FIG. 3, wherein a situation in which the method in FIG. 2 fails to traverse the NAT+firewall boxes and a more complete emulation of connection request is implemented. In this case, the SYN packet carries no control information, which instead is piggybacked on a succeeding ACK packet.

The inventor in the instant invention has experimented and experienced that the previous technique of sending a SYN packet succeeded by an ACK packet with control information will survive most of commercial firewalls.

A third more elaborated technique can also involve the cooperation of CT, in which it generates a SYNACK packet with zero payload to emulate a complete TCP three way handshake.

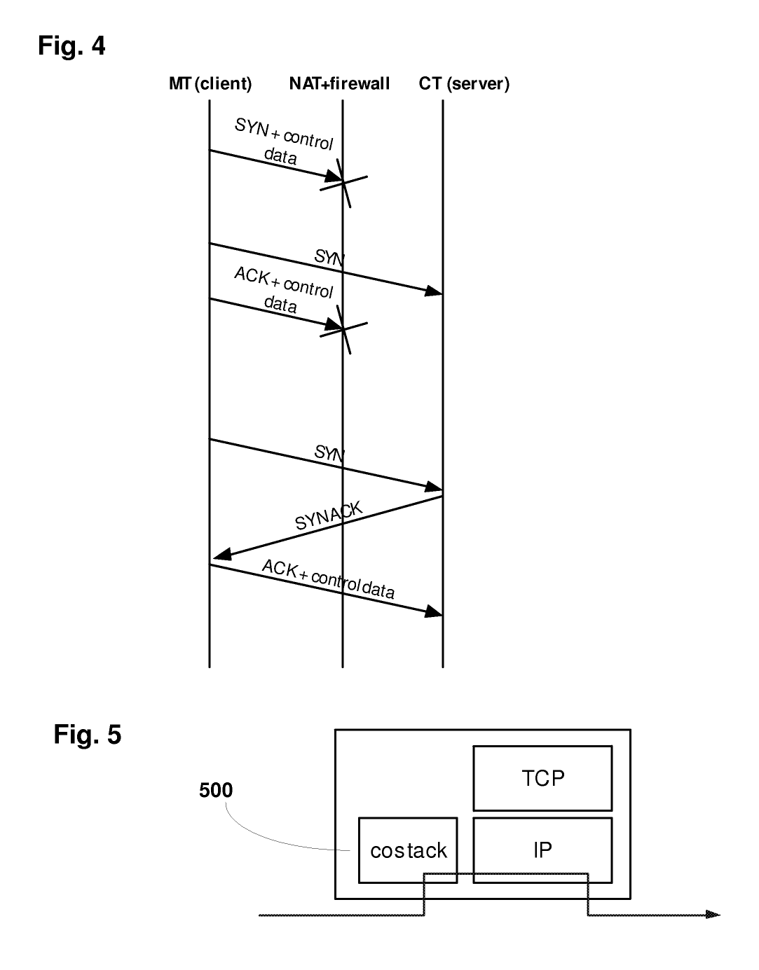

In general, we note that [T.1.1] a complete emulation of the establishment of a new connection between MT and CT succeeded by a packet carrying the control information constitutes by protocol definition a feasible method of solving the DCP mobility problem as shown in FIG. 4, wherein a complete emulation of connection setup to convey control information to CT. This method may be required if the method in FIG. 3 fails to traverse the NAT+firewall boxes. Notice that the exact same technique [T.1.1] can be used for the case of UDP and other transport layer protocols.

Let us now consider case (2). That is, that the communication between MT and CT does not follow a client/server model or if it does, CT does not perform the role of a server. We note that in this situation, the previous technique can no longer be used because in general the NAT and firewall boxes will not accept the emulation of a connection request since now CT does not perform the role of a server.

There are 2 key cases herein: the symmetric NATs and the non-symmetric NATs. It is noted that among non-symmetric NATs we can find full cone, restricted cone, and port restricted cone NATs but a full explanation of all these different NAT cases is out of the scope and irrelevant to the present invention. For whatever mobility is concerned, the key differentiator is that while symmetric NATs define mappings between source IP address and port number inside and outside the NAT that depend on the destination IP address, the mapping in the case of a non-symmetric NAT is independent of the destination IP address. We next propose techniques to solve each of these two scenarios.

For the case of non-symmetric NAT, since the mapping does not depend on the destination IP address (i.e. the IP address of the MT), [T.1.2] MT can generate a packet using the same destination IP address and port number that was using to communicate with CT when MT was at network Na. Notice that this packet will be able to traverse the NAT and firewall boxes at CT side even if MT has now a different source IP address, since by definition the NAT mapping does not depend on this address. Hence, a method to send control information from MT to CT is as follows: build a packet in the exact same way it was built when MT was communicating with CT via network Na and change its source IP address with the new IP address acquired in network Nb; on this packet, piggyback the control information and send it to CT.

For the case of symmetric NAT, we note that the previous technique will fail to cross the NAT box. Since the mapping depends on the destination IP address (i.e. the source IP address of MT), which changed after MT moved to Nb, the previous mapping can no longer be used. There are three manners of solving this problem:

(1). MT can use the source IP address that it used to use when it was at network Na. This solution is considered unfeasible though since it implies the generation of topologically incorrect packets (i.e. packets that traverse network Nb but that use a source IP address that is not in the subnet defined by Nb) and therefore subject to be dropped by routers performing egress filtering (a function implemented in many routers by which packets with a topologically incorrect source IP address are dropped).

(2). [T.1.3] A third box (refer to it as MB or middle box) outside network Na can intercept the control packet sent by MT to CT and change its source IP address and port number for that one used when MT was in network Na. Referring to FIG. 5, a costack module 500 at the IP level for the case of middle boxes is shown.

(3).[T.1.4] CT can punch a new hole in its NAT to allow the traversal of this NAT from MT via a new mapping considering the new IP address acquired by MT in network Nb. Notice that this technique requires CT to know the new IP address acquired by MT in network Nb before MT can send any control information, possibly inducing a deadlock situation. This deadlock situation however, can be resolved depending on the scenario. For instance, in the case of a soft handoff (i.e. the case in which MT acquires new connectivity from network Nb before it loses connectivity from network Na), MT can use network Na to convey the new IP address to CT.

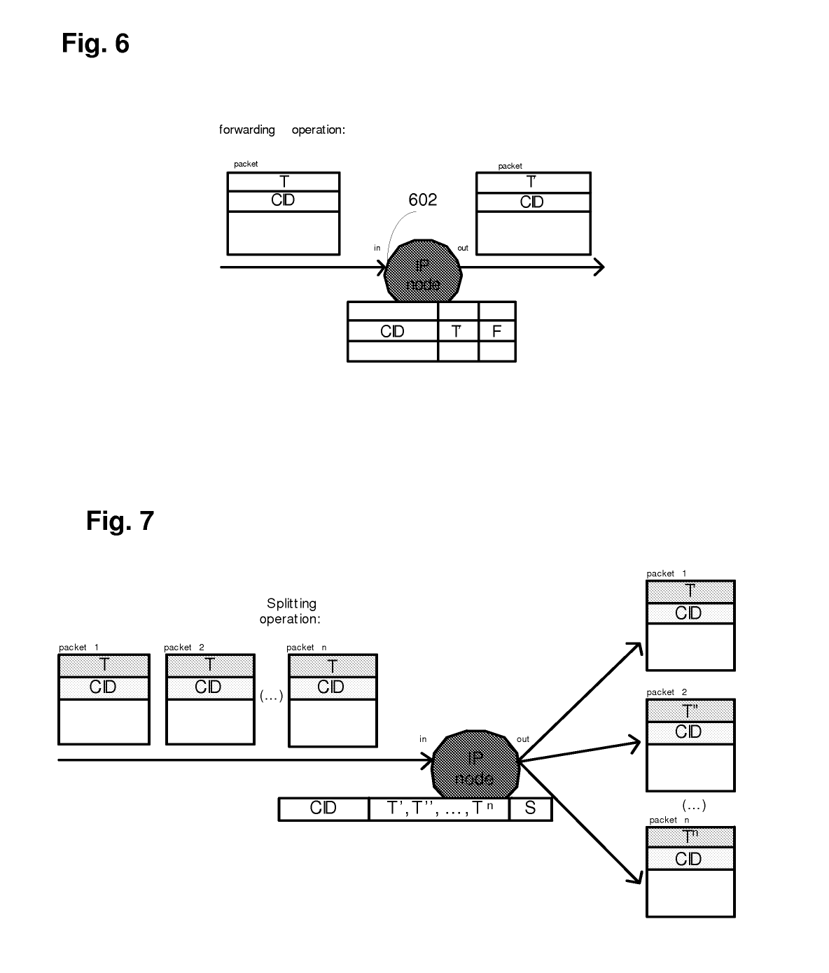

We observe that the only two feasible solutions are methods (2) and (3), since method (1) is subject to the problem of topologically incorrect packets. We refer to these 2 methods, i.e. methods (2) and (3), as techniques [T.1.3] and [T.1.4] respectively. We also observe that technique [T.1.3] can easily be implemented using the concept of c-forwarding, as defined in a former invention filed with the UNITED STATES PATENT OFFICE having patent application Ser. No. 11/______ by the inventor of the present invention. In FIG. 6, the c-forwarding operation implemented in an IP node. Upon receiving an IP packet labeled with a connection ID (CID), the node looks up its corresponding status table entry and swaps its original tetrad T with T′. C-forwarding allows the tracking of connections even after changes of IP address occur as well as provides a framework for swapping their tetrads (pairs of source and destination IP addresses and port numbers). These two functions are key in order to implement the method.

Methods for Solving the DDP Mobility Problem

Once CT has received the control information and is aware that MT is located at a different network Nb, it now has to continue to generate data packets in a way that they can reach MT at its new location. Such packets in general will also need to traverse NAT and firewall boxes to safely arrive at MT.

We observe that if techniques [T.1.1] and [T.1.2] were used to convey the control information from MT to CT, then the following technique can be used to solve the DDP mobility problem: in these cases, [T.2.1] the sending of the control information via methods [T.1.1] and [T.1.2] forced the punching of a hole in the NAT boxes; hence, CT can send packets to MT by using the reversed tetrad (i.e. swapping the source IP address and port number by the destination IP address and port number) from the control packet that it received from MT.

If technique [T.1.3] was used to convey the control information from MT to CT, then a similar technique to [T.1.3] can be used to solve the DDP mobility problem: in this case, [T.2.2] CT can send packets to MB (the same middle box used to solve the DCP mobility problem in technique [T2.2]); since MB received in first instance the control packets from MT to CT, it is aware of the tetrad needed to traverse the NAT boxes in the reverse path to MT; MB can then change tetrads of the data packets to the reverse of the tetrad carried by the control packets.

Finally, if technique [T.1.4] was used to convey the control information from MT to CT, [T.2.3] CT can use the same tetrad used to punch a hole through its NAT to now send data packets to MT.

Methods for Solving the UDP Mobility Problem

The following technique can be used to solve the UDP mobility problem: [T3] solve first the DCP mobility problem; notice that after the DCP mobility problem has be resolved, a NAT hole has been punched; then, use this hole and its corresponding tetrad to send data packets upstream from MT to CT. We observe that the method for solving the UDP mobility problem is trivialized due to the fact that the communication system has previously solved the DCP mobility problem.

In conclusion, the above presents a taxonomy of possible scenarios that must be resolved in order to provide IP mobility. Techniques [T.1.1], [T.1.2], [T.1.3], [T.1.4], [T.2.1], [T.2.2], [T.2.3] and [T3] are presented as alternative approaches to MIP and in particular to RFC 3519 with the advantage that (1) they do not require any reconfiguration of NAT and firewall boxes and (2) they do not introduce any additional security glitches to the IP communication system beyond those existing in static IP communications (since unlike MIP RFC 3519, no UDP port must be opened).

Interaction of the Mobility Protocol with the Socket Layer

Besides the design of a distributed protocol, IP mobility requires some sort of interaction with the socket layer in order to maintain connectivity. In particular, while at the IP layer IP addresses assigned to both networking devices and packets will change when MTs move across networks, in order to guarantee the survival of the connection packets must be tetrad-invariantly presented to the upper layers; that is, transport layer protocols (TCP, UDP, etc . . . ) must see packets carrying the same tetrads for the complete lifetime of a connection and in particular they must constantly see the tetrad used when MT was at the network in which the connection was created. We will refer to this problem as the socket feasibility problem.

A method to solve the socket feasibility problem is presented in this invention by which the concept of c-forwarding is used. A c-forwarding infrastructure allows two key functions: to provide CIDs or unique IDs to connections even if terminals move to new networks and tetrads change, and to provide a mechanism for swapping tetrads based on the notion of status table entries (see FIG. 6). In a basic form, a c-forwarding capable node maintains a status table, consisting of status table entries which are defined as pairs made of 1 CID and 1 tetrad. Upon receiving a packet generated by a mobile infrastructure, the c-forwarding node can uniquely identify this packet as belonging to a particular connection based on its CID (this CID can be carried in the packet). Then, using the status table, the c-forwarding node can swap the packet's tetrad by that indicated in its corresponding status table entry. We observe that the c-forwarding technique can most suitably resolve the socket feasibility problem via the following procedure. Upon receiving an IP packet, a c-forwarding node can use the packet's corresponding status table entry to swap the packets tetrad to a tetrad that will be accepted by the final destination socket. In particular, this new tetrad should be equal to the original tetrad used by the connection when it was first created. By programming status table entries accordingly, mobility can be achieved without breaking connections at the socket layer.

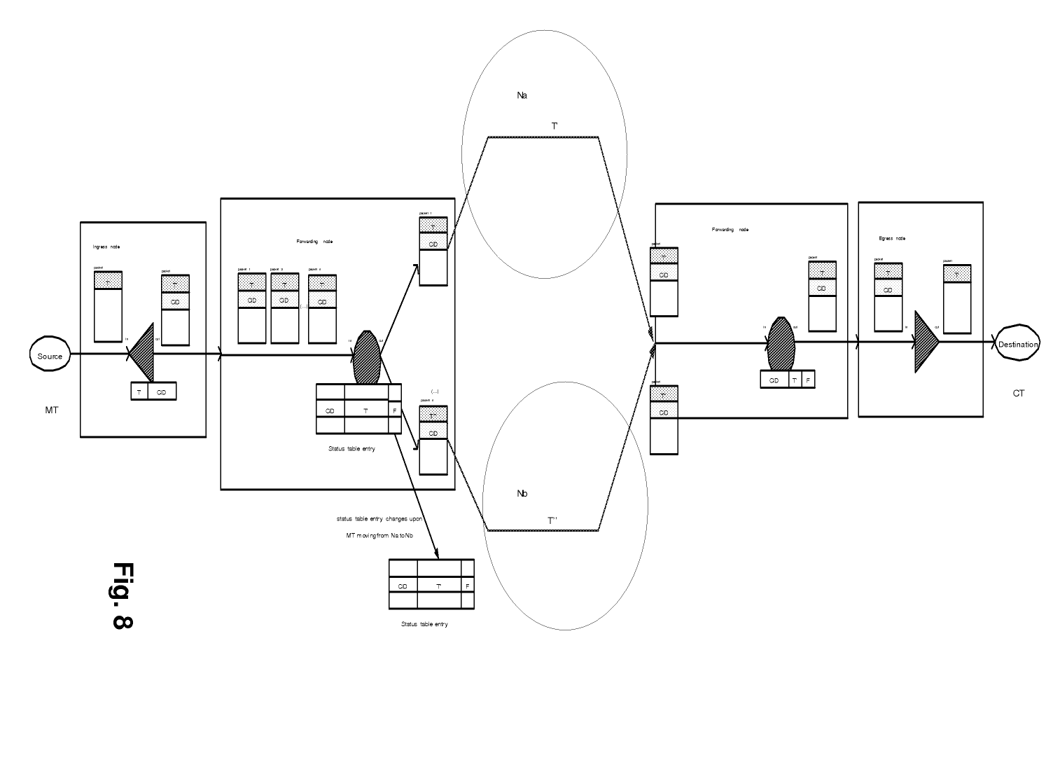

FIG. 7 illustrates the c-forwarding operation in splitting mode. Upon receiving an IP packet labeled with a connection ID (CID), the node looks up its corresponding status table entry and swaps its original tetrad T with one of the tetras indicated in this status table entry.

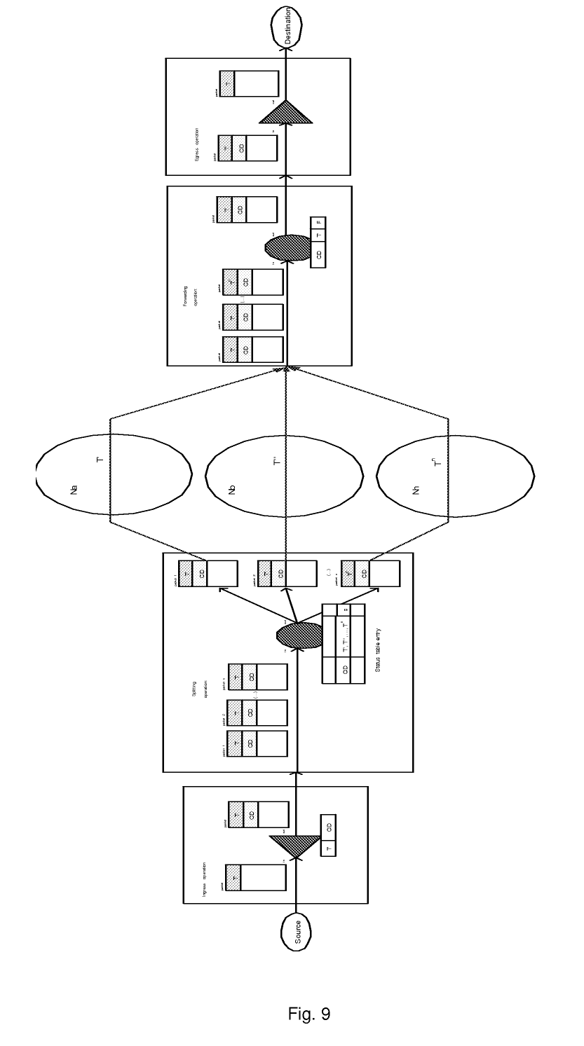

A complete example is shown in FIG. 8, in which 1 ingress c-node, 2 c-forwarding nodes in forwarding mode and 1 egress c-node are used to achieve mobility. FIG. 8 illustrates how c-forwarding operations can be used to solve the mobility problem without breaking transport and socket layers. Upon receiving a packet with tetrad T′, the ingress node assigns and piggybacks a connection ID CID to it. Upon receiving a packet, the first (most-left) forwarding node is programmed to assign tetrad T′ to packets with connection ID equal to CID (i.e. no changes to the tetrad are done in the first instance). Upon receiving a packet, the second (most-right) forwarding node is programmed to assign tetrad T′ to packets with connection ID equal to CID (i.e. no changes to the tetrad are done in the first instance). Upon receiving a packet with tetrad T′, the egress node removes the connection ID from it.

Now suppose that MT moves from network Na to network Nb and assume that T″ is the tetrad that leads packets to travel from MT to CT via network Nb. Then, in order to achieve mobility, only one operation needs to be performed: Upon moving from network Na to network Nb, the first (most-left) forwarding node modifies the status table entry assigned to connection ID CID to use tetrad T″ instead of tetrad T′. Henceforth, upon receiving a packet with connection ID equal to CID, the forwarding node will change its tetrad to T″. The previous procedures guarantees that even upon moving to a new network Nb, packets are sent and received at the transport and socket layer via a mobility-invariant tetrad. In the case of our previous example, this mobility-invariant tetrad is T′.

Generalization: from IP Mobility to Multipath Packet Delivery (Network Convergence)

We next explain how the present IP mobility invention can be naturally generalized to solve the network convergence problem. Consider FIG. 8, the mobility infrastructure can be generalized to support MPD if we substitute the left-most forwarding node with a splitting node, as shown in FIG. 9. A splitting node acts similarly to a forwarding node except that instead of supporting one single outgoing tetrad, it can support multiple outgoing tetrads at the same time. This allows packets of the same connection to be sent onto different networks, effectively splitting a connection onto multiple paths.

FIG. 9 presents an IP system capable of performing MPD. As mentioned, the only difference between this system and the previously explained system in FIG. 8 is the use of a splitting node. The splitting node operates as follows: Upon receiving a packet with connection ID CID, it swaps the current tetrad in the packet for one of the tetras found in its corresponding status table entry.

Notice that the election of a tetrad among all possible tetrads found in the corresponding status table entry defines the path that the packet will use to reach the destination. Such decision should preferably be based on the basis of a certain optimization criterion. In general, the tetrad for each packet should be chosen in a way that the total experienced QoS is maximized.

As a simple illustrative example, suppose that the source is located at a place where it can reach connectivity from both an HSDPA network and a WIFI network, so that the splitting node in the MPD infrastructure assigns two tetrads to the status table entry corresponding to this user's connection; for instance assume that tetrad T′ corresponds to the HSDPA path while tetrad T″ corresponds to the WIFI path. Suppose that the HSDPA network and the WIFI network provide an available bandwidth of 5 and 20 Mbps, respectively. Then, a possible QoS scheme to choose tetrads at the splitting node works as follows:

1 out of 5 packets received from the user will be sent via tetrad T′.

4 out of 5 packets received from the user will be sent via tetrad T″.

Three more final notes are next provided. First, that the elements introduced in the present invention can be inserted at arbitrary places in the network as long as such locations are suitable to accomplish their final objective of (1) enabling a mobile communication system or, more in general, (2) of enabling total convergence. For instance, a possible implementation could purely be end-to-end in which the ingress and egress nodes and the forwarding and splitting nodes are only introduced at the terminals. A second possible implementation could involve the implementation of these modules in middle boxes. So for instance, one can easily think of a system in which the ingress and egress nodes and the forwarding and splitting nodes are implemented in middle boxes capable of intercepting packets from MT to CT. Second, that while for the most part of the previous discussion we have focused on the case of single sender and single receiver, such choice was only made for the sake of simplicity. The techniques introduced in the present invention can be equally applied to communications systems with multiple senders and multiple receivers. Examples of such cases are multicast, broadcast and anycast communications.

Third, we should notice that the term MPD is similar to the commonly used term “bandwidth pooling”. Some technologies have been proposed to perform bandwidth pooling. Mushroom Networks (MN) and WiBOOST (WB) being two of the most well-known examples. The main difference between the present invention and MN-WB is that the latter are application based solutions while the present invention is implemented at core of the IP suite. The following example will help to clarify this point. Let us consider the case of an HTTP transaction. Using MN-WB technology, the TCP connection carrying the HTTP transaction is terminated at some middle box (MB). Suppose that there are N available networks from MB to the HTTP server, then MB will open N TCP connections to the HTTP server, one on each of these networks. So in summary, there is one connection from the HTTP client to MB, and N connections from MB to the HTTP server. Now upon receiving an HTTP transaction request from the client, MB parses the TCP payload to find all HTTP GET requests and forwards each of these request to one of the TCP connections established between MB and the HTTP server. With this mechanism, all GET requests can be serviced in parallel using multiple paths.

As we notice from the example, MN-WB technologies are application dependent in the sense that they require a separate solution for each application layer protocol. The example above was specific to HTTP and may not work for all possible applications. An example is video streaming, in which there is only one GET request and the rest of the transaction corresponds to the streaming of a movie over a single connection. For all application layer protocols based on single GET request methods (such as the video streaming case), the degree of parallelization is 1 (i.e. no parallelization at all), and MN-WB type of technologies fail to achieve bandwidth pooling.

The bandwidth pooling provided by MN-WB technologies is very coarse in the sense that the minimum unit of information that can be switched to a specific path is a complete connection. In contrast, the present invention introduces a mechanism to achieve bandwidth pooling in a per packet basis, i.e. achieving the finest possible resolution (in IP networks, the minimum switchable unit of information is a packet).

One significant implication of the above is that the present invention can enable bandwidth pooling for all applications, including those based on single GET request methods (such as the above video streaming example).

IPv4 Versus IPv6

While IPv6 enables each terminal to have a public IP address, it is commonly accepted that even with a massive deployment of this new protocol NAT boxes will continue to exist. This is specifically true to those end-users and enterprises that prefer to administer their own local area networks, using private and non-public routable IP addresses, perhaps for security reasons. Hence, the techniques introduced by the present invention are not limited to the case of IPv4. Indeed, they can also be deployed in IPv6 networks at least in cases where more than one NAT box exists.

### SPECIFIC EMBODIMENTS

Referring again to FIG. 1, in accordance with one embodiment of the present invention, a possible setup of the present invention is provided in FIG. 1. Each mobile capable node implements a module referred in this invention as costack, or cooperative stack 102. Costack 102 is responsible to generate the packets described in the techniques presented in this invention to solve the DCP, DDP and UDP mobility problems. In addition, costack 102 is responsible to implement the c-forwarding operations for changing packet tetrads in order to guarantee both (1) the correctness of the mobility and MPD protocol and (2) the correct resolution of the socket feasibility problem.

Costack 102 can be implemented in any legacy IP node, since its presence is unnoticeable to the current IP stack. Costack intercepts packets both going up or down the current IP stack and returns them to the current IP stack in a way that this last one will not be disrupted in its normal operational flow.

The solution presented in this invention is not limited by any means to any kind of specific form in terms of the location of costack modules. So for instance, in end-to-end solutions, costack 102 can be located at both the MT and the CT. In gateway based solutions, costack 102 can be implemented in MT and in a set of middle boxes (for instance when using techniques [T.1.3] and [T.2.2], the middle box should carry a costack module). A possible example of middle box with a costack module is presented in FIG. 5.

Furthermore, the present solution also differs from the Skype NAT traversal technology in the sense that the former is independent to the application protocol being used, while the latter assumes voice (or real time) applications. The present solution can achieve this quality because it is implemented at the IP layer, rather than the application layer.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A communication system comprising:
a mobile terminal adapted to selectively use the resources of at least two networks to communicate with a corresponding terminal via IP connection;
an IP node comprising an interception technique; and
an IP layer having a cooperative stack (costack) being inserted next to or at the save level thereof;
wherein the costack generates a new control plane packets or manipulates existing data plane packets.

2. The system of claim 1 wherein the costack module is disposed in the mobile terminal, the corresponding terminal, or a middle box.

3. The system of claim 1, wherein the costack can be implemented in any legacy IP node

4. The system of claim 1 wherein a SYN packet carries no control information, which instead is piggybacked on a succeeding ACK packet.

5. The system of claim 1 wherein the control plane packet is embodied into a SYN packet.

6. The system of claim 1 wherein the mobile device moves across different networks or when communication paths are set across NAT and firewall boxes.

7. A method comprising the steps of:
providing a mobile terminal adapted to selectively use the resources of at least two networks to communicate with a corresponding terminal via IP connection;
providing an IP node comprising an interception technique; and
providing an IP layer having a cooperative stack (costack) being inserted next to or at the save level thereof;
wherein the costack generates a new control plane packets or manipulates existing data plane packets.

8. The system of claim 7 wherein the costack module is disposed in the mobile terminal, the corresponding terminal, or a middle box.

9. The system of claim 7, wherein the costack can be implemented in any legacy IP node

10. The system of claim 7 wherein a SYN packet carries no control information, which instead is piggybacked on a succeeding ACK packet.

11. The system of claim 7 wherein the control plane packet is embodied into a SYN packet.

12. The system of claim 7 wherein the mobile device moves across different networks or when communication paths are set across NAT and firewall boxes.

13. The method of claim 7, wherein the interception technique comprising the steps of:
generating special packets;
intercepting the special packets,
processing the special packets; and
dropping the special packets; thereby no actual connection is initiated by the upper layer protocols.

14. A communication system having an interception technique comprising:
means for generating special packets;
means for intercepting the special packets,
means for processing the special packets; and
means for dropping the special packets; thereby no actual connection is initiated by the upper layer protocols.
